(19) United States
(12) Patent Application Publication
(10) Pub. No.: US 2005/0185103 A1
(43) Pub. Date: Aug. 25, 2005

(54) System and method for displaying an image and playing an associated message

(76) Inventors: Rudy Woodard, Boston, MA (US); Joseph Geringer, Merrimack, NH (US); Timothy J. Trepacz, Auburn, NH (US); Stephen R. Lyman, Hudson, NH (US)

Correspondence Address: Gunnar G. Leinberg, Esq.;NIXON PEABODY LLP, Clinton Square, P.O. BOX 31051, Rochester, NY, 14603-1051, US

(21) Appl. No.: 10/782,437

(22) Filed: Feb. 19, 2004

(51) Int. Cl. H04N 7/08

(52) U.S. Cl. 348/739

(57) ABSTRACT

A system and method for an image display is provided. Generally, the image display has one or more exterior images displayed on an exterior surface of a image display housing and one or more interior images stored within the image display housing and removably displayed on one or more interior frames. The image display also has audio storage for storing one or more audio segments associated with exterior and interior images and an audio player for broadcast audio segments. The image display also has one or more frame selection buttons associated with the one or more interior frames and a control circuit wherein the control circuit selects one of the audio segments to broadcast based on activation of the play button and activation of one or none of the one or more frame selection buttons.

### FIELD OF THE INVENTION

The present invention is generally related to an image displays, and more particularly is related to an image display for both storing and displaying images as well as storing and playing audio segments associated with the images.

### BACKGROUND OF THE INVENTION

Picture frames allow individuals to display photographs of friends, family, momentous occasions, etc. The frame protects the photograph and often provides an ornamental border to accent the photograph. In addition to picture frames, paperweights and other novelty items for placement on desks and coffee tables allow photographs to be displayed on the surfaces of the items. For example, a decorative cube displays five photographs, one on the top of the cube and one on each of the four sides of the cube.

In addition to displaying the photograph, frames have also been equipped with electrical circuitry that plays a previously recorded audio segment. A user presses a button located on the frame, which activates the electrical circuitry causing an audio signal to be transmitted to a speaker located on the frame. This allows the user to reminisce both visually through the photograph and audibly through the audio segment. The audio segment could include the individual's voice in the photograph, or a song, or speech associated with the photograph. For example, a frame displaying a baseball card could play a sports broadcast of a winning homerun by the baseball player featured on the card.

Accordingly, it will be apparent that there continues to be a need for an image holder that easily stores multiple photographs and audio segments associated with the stored photographs.

Thus, a heretofore-unaddressed need exists in the industry to address the aforementioned deficiencies and inadequacies.

### SUMMARY OF THE INVENTION

Embodiments of the present invention provide a system and method for displaying images. Briefly described, in architecture, one embodiment of the system, among others, can be implemented as follows. The image display can comprise one or more exterior images displayed on an exterior surface of an image display housing and one or more interior images can be stored within the image display housing and removably displayed on one or more interior frames. The display also has an audio storage with one or more audio segments associated with exterior and interior images. The image display also has an audio player wherein activation by a first play button broadcast one of the one or more audio segments.

Embodiments may include one or more of the following. The image display can also have one or more frame selection buttons wherein activation of one of the one or more frame selection buttons displays one or more of the interior images by moving one of the one or more frames out of the image display housing. The image display can also have one or more frame selection buttons associated with the one or more interior frames and a control circuit wherein the control circuit selects one of the audio segments to broadcast based on activation of the first play button and activation of one or none of the one or more frame selection buttons.

In another aspect, the image display may have an audio recorder wherein activation by a record button records one of the one or more audio segments to the audio storage, and a control circuit identifies one of the one or more recorded audio segment with an associated image based on activation of the record button and activation of one or none of the one or more frame selection buttons.

In another aspect of the image display, one interior image is displayed on a front and another interior image is displayed on a back of each of the one or more interior frames. The control circuit selects one of the audio segments to broadcast based on activation of the first play button or a second play button and activation of one or none of the one or more frame selection buttons. The first play button is associated with images on a front side of each of the one or more interior frames and the second play button is associated with images on a back side of each of the one or more interior frames.

In another aspect of the image display, the control circuit identifies one of the one or more recorded audio segment with an associated image based on activation of the record button, an image record selector, and activation of one or none of the one or more frame selection buttons. The image record selector differentiates between images on a front side of each of the one or more interior frames and images on a back side of each of the one or more interior frames.

A method of one embodiment can be broadly summarized by the following steps: receiving a signal from a first play button and selecting an audio segment associated with an image based on receiving a signal from one or none of one or more frame selection buttons associated with one of one or more frames of the image display and receiving the signal from the first play button. Selecting and playing an audio segment associate an exterior image is accomplished when none of the one or more frame selection buttons is activated and the signal from the first play button is received. Selecting an audio segment associated with an interior image for play is accomplished when one of the one or more frame selection buttons is activated and the signal fro the first play button is received.

In another aspect, the method includes receiving a signal from a second play button and selecting an audio segment associate with a back facing image when one or none of the one or more frame selection buttons is activated and the signal for the second play button is received. The method can also include the step of selecting and playing an audio segment associated with a front facing image when one or none of the one or more frame selection button is activated and the signal for the first play button is received.

The image display and method allows a user to easily display and store images along with audio segments associated with the images. Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram providing a top perspective view of an image display with audio device, in accordance with a first exemplary embodiment of the invention.

FIG. 2 is a schematic diagram providing a front view of the image display with audio device of FIG. 1 with a frame of a stored image partially extending from the top for display.

FIG. 3 is a schematic diagram providing a top view of the image display with audio device of FIG. 1.

FIG. 4 is a schematic diagram providing a side view of the image display with audio device of FIG. 1.

FIG. 5 is a block diagram illustrating the interaction of the components of the audio device.

FIG. 6 is a flowchart illustrating a method of playing an audio segment based on an image that is displayed, in accordance with the first exemplary embodiment of the invention.

FIG. 7 is a flowchart illustrating a method of recording an audio segment based on an image that is displayed, in accordance with the first exemplary embodiment of the invention.

FIG. 8 is a schematic diagram providing a top perspective view of an image display with audio device, in accordance with a second exemplary embodiment of the invention.

FIG. 9 is a flowchart illustrating a method of playing an audio segment based on an image that is displayed, in accordance with the second exemplary embodiment of the invention.

FIG. 10 is a flowchart illustrating a method of recording an audio segment based on an image that is displayed, in accordance with the second exemplary embodiment of the invention.

### DETAILED DESCRIPTION

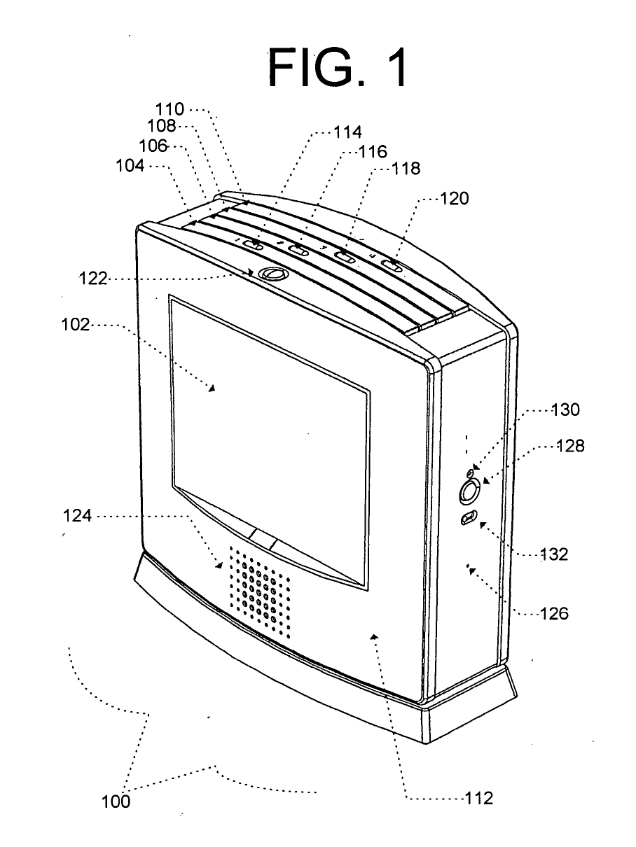

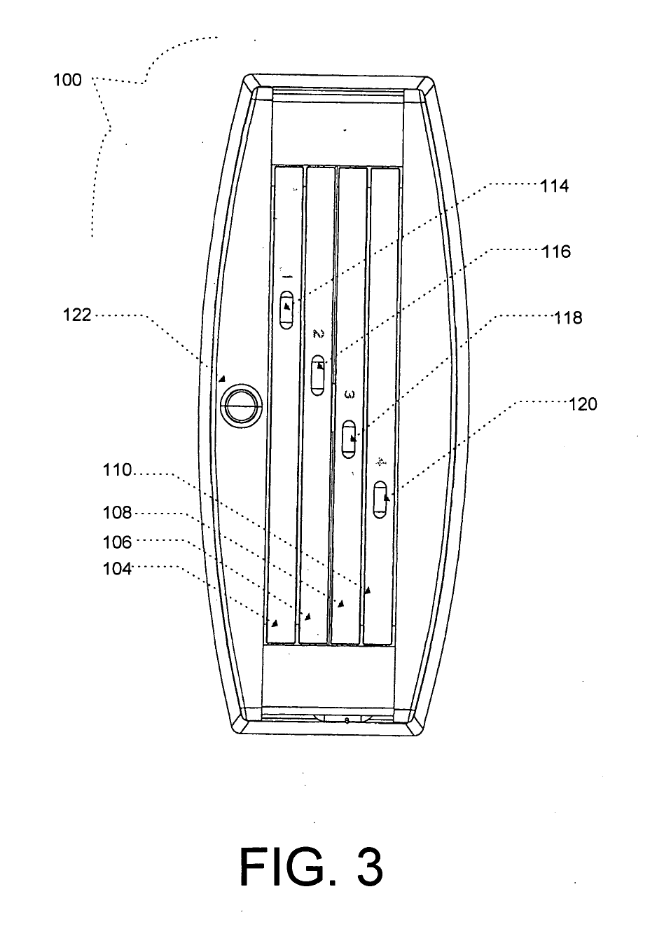

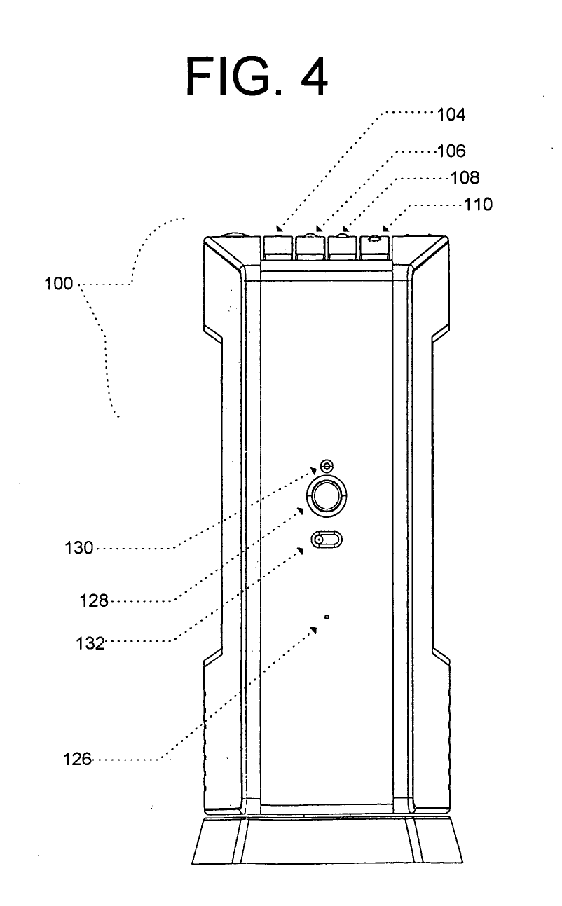

A top perspective view of an image display device 100 with audio device, in accordance with a first exemplary embodiment of the invention, is shown in FIG. 1. FIG. 3 is a top view further illustrating the image display device 100, while FIG. 4 is a side view further illustrating the image display device 100. Referring to FIG. 1, FIG. 3, and FIG. 4 the image display device 100 has a front display 102, a frame one 104, a frame two 106, a frame three 108, and a frame four 110 secured within the image display device 100. An image displayed via the front display 102 is inserted within a front cover 112 and provides for a permanent display of the image. The four frames 104, 106, 108, 110 are temporarily secured within the image display device 100 and also maybe temporarily displayed by user selection as is described in detail below. The front display 102 and four frames 104, 106, 108, 110 are used to display and store photographs or images. It should also be understood that a variety of other items could be displayed and stored within the front display 102 and frames 104, 106, 108, 110 for example, but not limited to sports cards, greeting cards, and other memorabilia. It should be noted that more or fewer frames may be provided within the image display device 100.

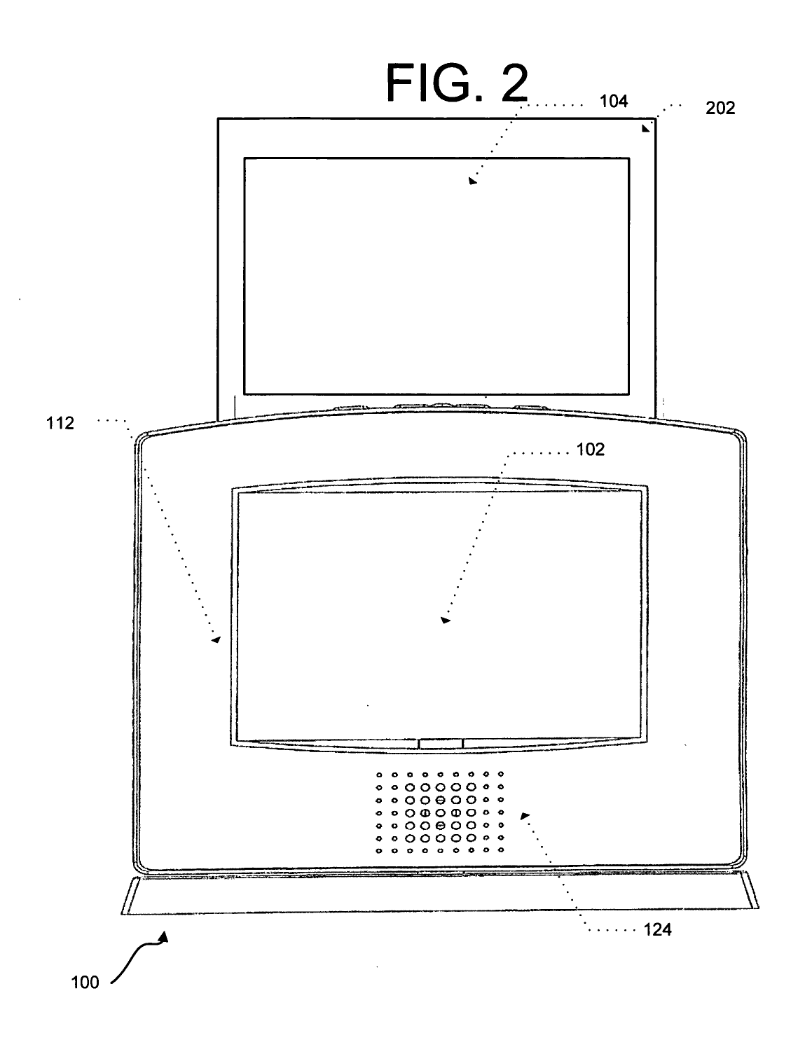

The user displays a secured frame by selecting the frame to display and pressing a button associated with that frame. Each frame has an associated frame selection button, i.e., frame one 104 has a frame one selection button 114, frame two 106 has a frame two selection button 116, frame three 108 has a frame three selection button 118, and frame four 110 has a frame four selection button 120. A user displays frame one 104, for example, by activating the frame one selection button 114. Once the frame one selection button is pressed, frame one 104 slides vertically upward displaying the image within frame one 104 (as shown in FIG. 2.). The image associated with the frame is displayed on the front side of the frame above the front display 102 (as shown in FIG. 2.). Once the user is finished viewing the image associated with frame one 104, the user can press frame one 104 back down within the image display device 100 for storage. Frames two 106, three 108, and four 110 similarly can be displayed by activating their respective frame selection buttons, 116, 118, and 120.

A spring mechanism (not shown) is employed within the image display device 100 to raise the frames from within the image display device 100. By pressing a frame selection button 114, 116, 118, 120 the spring mechanism is released and forces the associated frame 104, 106, 108, 110 upward into a display position above the front display 102 (as shown in FIG. 2). Once the image has been viewed, the spring is compressed back into storage position by the user pressing the frame 104, 106, 108, 110 back down within the image display device 100. A damper (not shown) can also be employed with the spring mechanism to provide a smooth motion of the frame 104, 106, 108, 110 from storage position to display position. It should also be understood by an individual having ordinary skill in the art that a variety of mechanisms can be employed to move the frame 104, 106, 108, 110 from within the image display device 100, for example, but not limited to a motor or lever mechanism. In addition, one having ordinary skill in the art will appreciate that switching the frame 104, 106, 108, 110 from the display position to the storage position may be performed automatically via use of a motor that moves the frame 104, 106, 108, 110 upon pressing the frame selection button 114, 116, 118, 120 a second time, or pressing a separate close button (not shown).

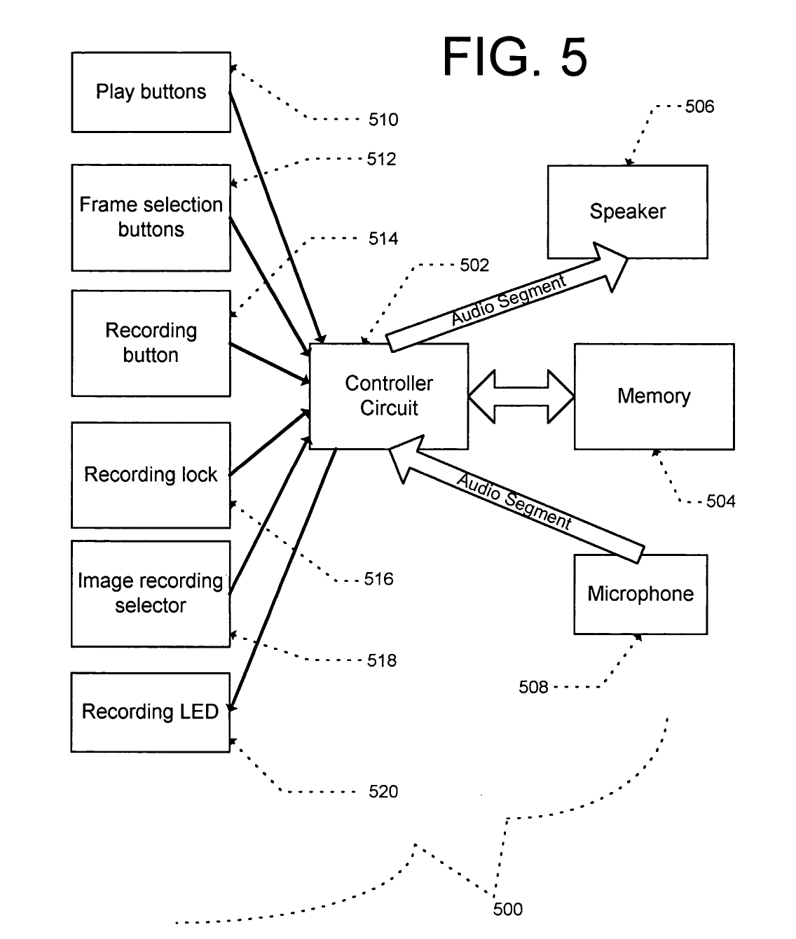

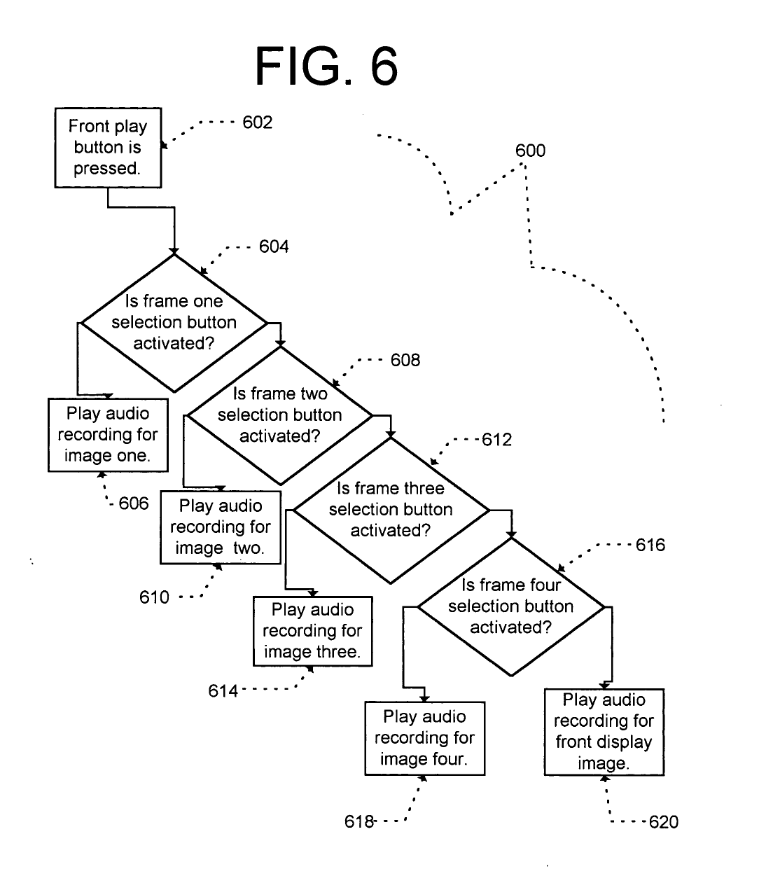

Along with displaying images, the image display device 100 also includes components for playing and recording audio segments. The front display 102 and each of the four frames 104, 106, 108, 110 can have a stored audio segment associated with each of them. The user plays the audio segment by pressing one of the frame selection buttons 114, 116, 118, 120 and pressing a front play button 122. The audio segment is then broadcast over a speaker 124 located on the front side of the image display device 100. The method and components used to play audio segments are discussed in more detail in the specification section associated with FIGS. 5 and 6.

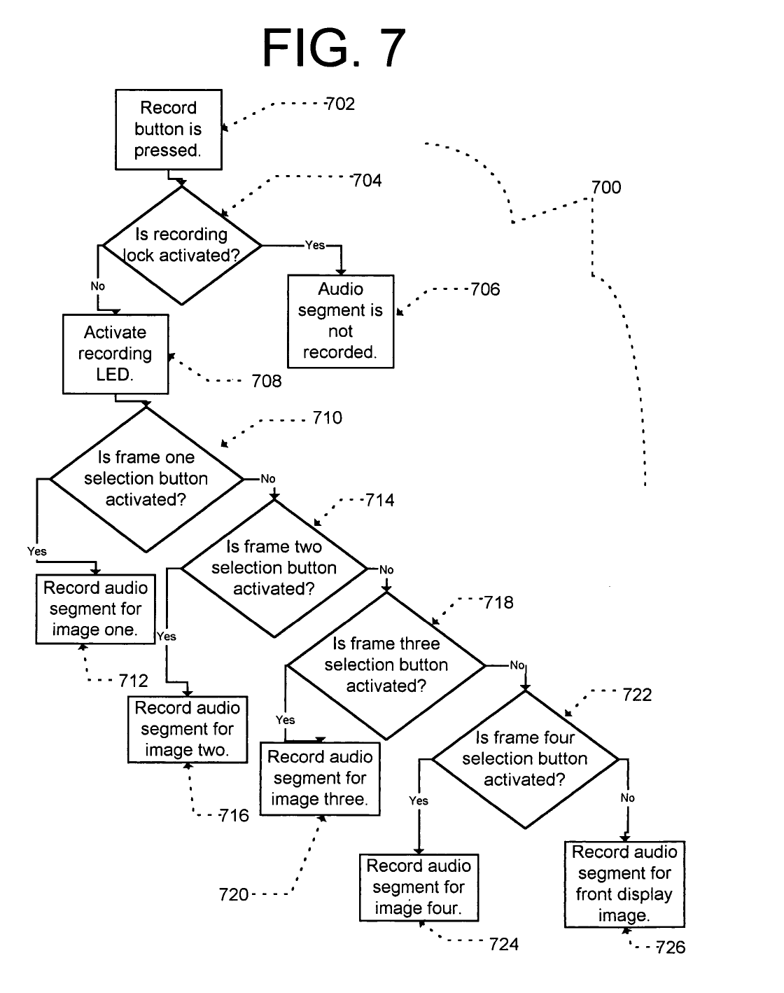

The image display device 100 also has a microphone 126 and record button 128 to allow the user to record an audio segment for each of the four frames 104, 106, 108, 110 and front display 102. The user selects the image to record the respective audio segment, presses the record button 128 and speaks into the microphone 126. While recording, a record light emitting diode (LED) 130 illuminates, signaling to the user that the audio segment is being recorded. At the completion of the audio segment the user releases the record button 128 and the audio segment is stored for later playback within a memory 504 (FIG. 5). To prevent accidentally recording over an audio segment, the image display device 100 also may have a record lock 132. When the record lock 132 is activated the user is prevented from recording an audio segment. This allows a user that wishes to save a recording for long term or permanently, to prevent the accidental recording over of a previously recorded audio segment. When the record lock 132 is deactivated the user again can record over previously recorded audio segments. The method and components used to record audio segments are discussed in more detail in the specification section associated with FIGS. 5 and 7.

Referring further to FIG. 2, the front side of the image display device 100 has frame one 104 extending through the top of the image display device 100. The front cover 112 has the front display 102, which may be made of glass or a transparent material such as plastic or any other transparent material. The front display image associated with the front display 102 is stored in a slot located within the front cover 112. The front display image shows through the transparent window of the front display 102. The speaker 124 is located under the front display, however, the speaker 124 can be located on any of the surfaces of the image display device 100. Frame one 104 is secured behind the front display 102 (in the stored position) within the image display device 100. By pressing the frame one selection button 114, frame one 104 is moved to the display position above the image display device 100. The frames 104, 106, 108, 110 can also be made of glass or a transparent material, with a slot for holding an image. In addition, borders 202 of each frame 104, 106, 108, 110 can have a decorative portion to accent the display of the images. When the user has completed viewing image one on frame one 104 the user can press the frame one 104 back into the image display device 100. The user can then select the frame two selection button 116 to view image two on frame two 106. Similarly, frame two 106 is moved from a storage position located behind frame one 104 to a display position above the image display device 100.

Referring further to FIG. 3, the play button 122 is located towards the front on the top of the image display device 100, however, the play button 122 can be located anywhere on the image display device 100 that is accessible by the user. Frame one 104 is positioned behind the play button 122. The frame one selection button 114 is located on the top surface of frame one 104. Frame two 106 is located next in line behind frame one 104 with the frame two selection button 116 located on frame two's 106 top surface. Similarly, frames three 108 and four 110 are located in sequence behind each other with the frame three selection button 118 and frame four selection button 120 located on the top surfaces of their respective frames 108, 110.

In another embodiment not shown, the frame selection button can be composed of switches and latches located within the image display device 100. A frame selection switch is activated by pressing down on the top surface of the selected frame. The downward pressure releases the latch holding the frame in a storage position allowing the frame to slide up into a display position. The movement of the latch can also activate a switch to signal the audio components that the frame is in a display position. The frame could then be pushed back down into a storage position within the image display device 100 by pressing downward on the top surface of the frame. Once the entire frame is within the image display device 100 the latch catches the frame and holds the frame in the storage position. The movement of the latch signals that the frame is no longer selected and is in the storage position.

Referring further to FIG. 4, the microphone 126, record button 128, record lock 132, and a record LED 130 (or another illuminative device) are located on the side of the image display device 100. The frames 104, 106, 108, 110 extend vertically through the top of the image display device 100. Each frame 104, 106, 108, 110 preferably has a top surface that matches the surface of the image display device 100, although matching is not a necessity. The frames 104, 106, 108, 110 also have a clear front portion for displaying the image within the frame as discussed earlier. Each frame 104, 106, 108, 110 can have a slot located on the side of the frame 104, 106, 108, 110 wherein the images can be slid into position from the side of the frame 104, 106, 108, 110. In another aspect the frames could have clips or a different securing mechanism on the front surface that holds the image in place.

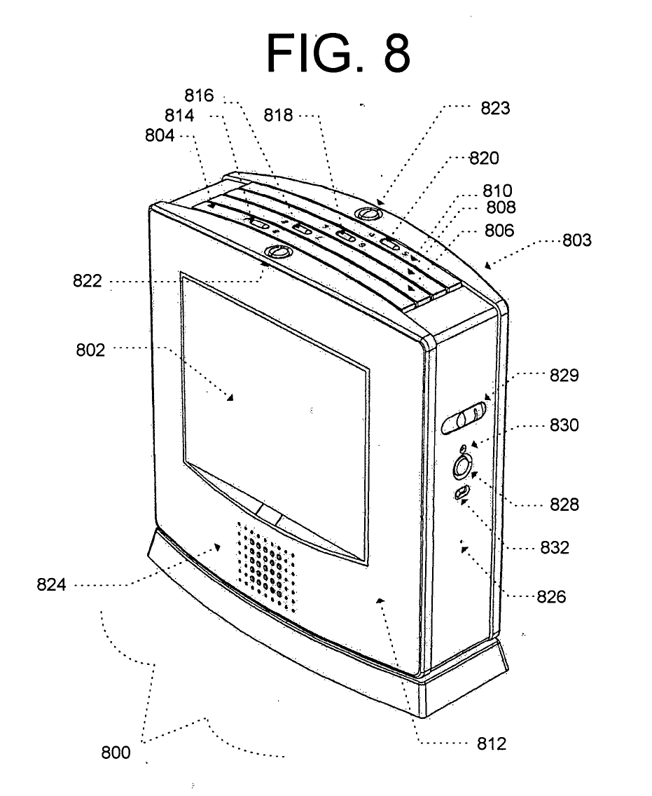

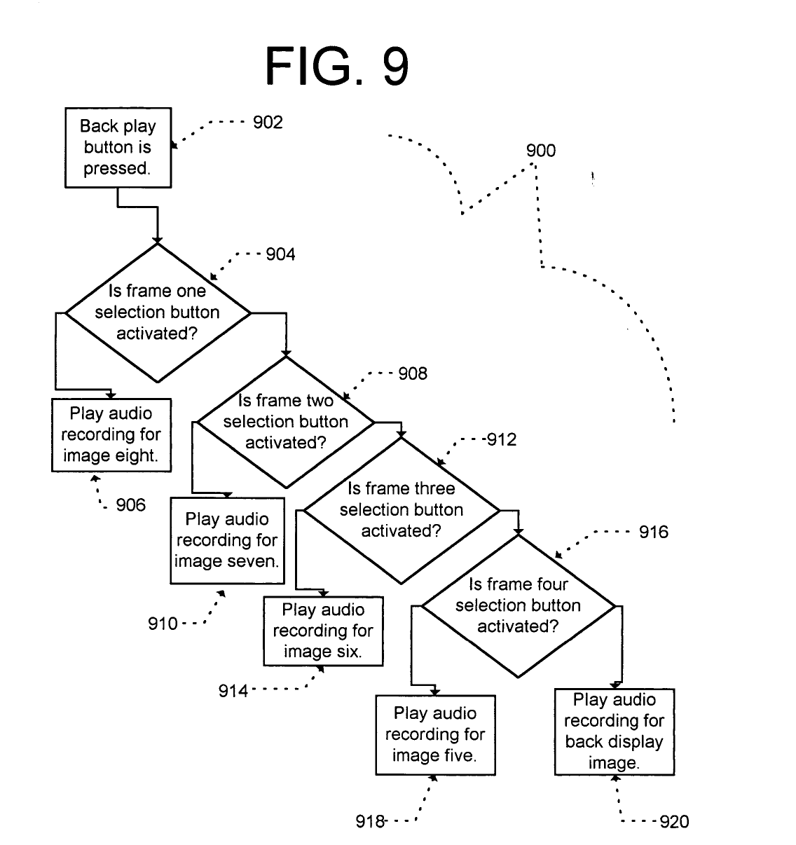

Referring to FIG. 5, a block diagram of the audio component 500 is shown. A controller circuit 502 receives input signals from input/output devices, such as, switches and buttons located on the surface of the image display device 100. These switches and buttons comprise play buttons 510, frame selection buttons 512, a record button 514, a record lock switch 516, and image record selector switch 518. The frame selection buttons 512 comprise the four frame selection buttons 114, 116, 118, 120. The frame selection buttons 512 signal which image the user is currently viewing to the controller circuit 502. In accordance with the first embodiment of the invention, the image display device 100 has the front play button 122 associated with the play buttons block 510, which is capable of signals to the controller circuit 502 to play an audio segment previously stored in a memory 504. In accordance with the second embodiment of the invention, the image display device 800 (FIG. 8) has a front play button 822 and a back play button 823 associated with the play button block 510, in which pressing the different play buttons 822, 823 causes the controller circuit 502 to play different audio segments. The methods used by the controller circuit 502 to select an audio segment for broadcast in the first and second embodiments are discussed in more detail in the specification sections associated with FIGS. 6 and 9.

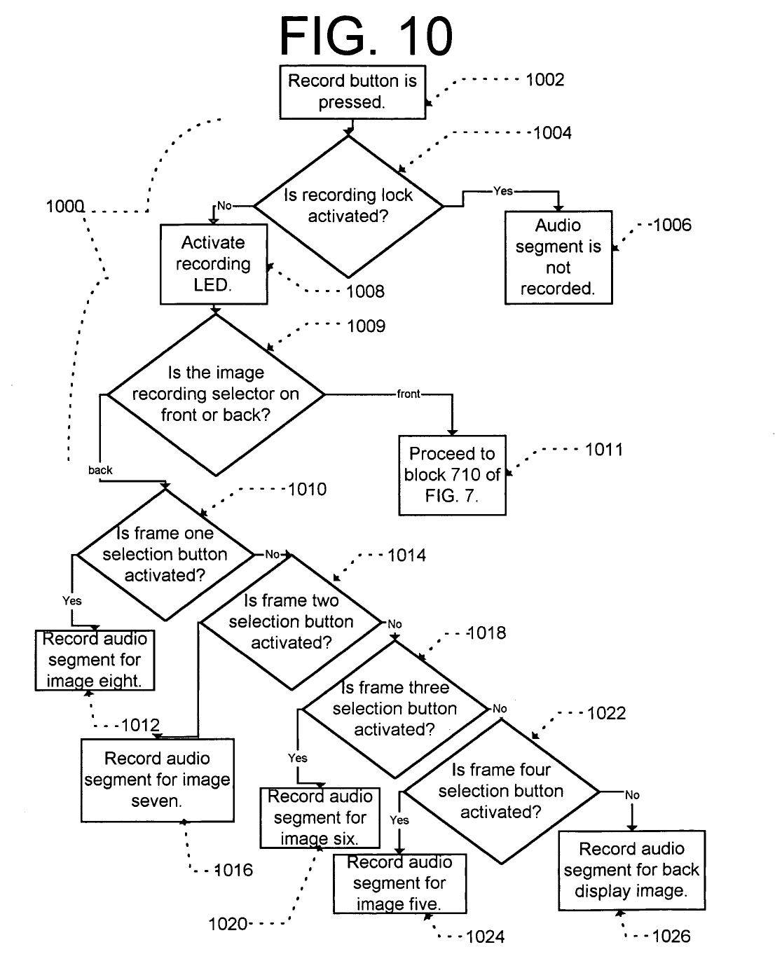

Referring to FIG. 5 the record button 514 signals to the controller circuit 502 to record a new audio segment to the memory 504. The record lock 516 signals to the controller circuit 502 not to record any new audio segments and to ignore signals from the record button 514. The image record selector 518 signals to the controller circuit 502 which audio segment to record. The image record selector 518 is discussed in more detail in the specification section associated with FIG. 10. The controller circuit 502 may illuminate the record LED 520 to signal to a user that the controller circuit 502 is recording the audio segment received by the microphone 508 to the memory 504. Audio segments are stored in the memory 504, however, a variety of other recording media could be used and are within the scope of the invention, for example, but not limited to electronic and optical memory. In addition, a variety of formats can be used to store the audio segments, for example, but not limited to Motion Picture experts group-1 audio layer-3 (MP3), Windows Audio Video (WAV), or Windows Media Audio (WMA).

When the play buttons 510 are selected, the controller circuit 502 responds by selecting a correct audio segment from memory 504 based on the algorithm shown in FIGS. 6 and 9. The controller circuit 502 then broadcasts the audio segment over the speaker 506. When the record button 514 is selected the controller circuit 502 responds by selecting a correct location in memory 504 corresponding to an associated image based on the algorithm shown in FIGS. 7 and 10. The controller circuit 502 then receives the audio segment from the microphone 508 and stores it in the specified location.

FIG. 6 is a flowchart illustrating a method of playing an audio segment based on an image that is displayed in accordance with the first exemplary embodiment of the invention. Referring to FIG. 6, the controller circuit 502 selects the correct audio segment to play based on a method of FIG. 6, also referred to herein as a front play button algorithm 600. The algorithm allows the controller circuit 502 to determine which image the user is currently viewing and play the audio segment corresponding to that image with the user only having to press the front play button 122 (FIG. 1). Once the user presses the front play button (block 602), the controller circuit 502 determines whether the frame one selection button 114 is activated (block 604). If the frame one selection button 114 is activated the controller circuit 502 plays the audio segment associated with image one on frame one (block 606). If the frame one selection button 116 is not activated the controller circuit 502 determines whether the frame two selection button 116 is activated (block 608). If the frame two selection button 116 is activated the controller circuit 502 plays the audio segment associated with image two on frame two (block 610). If the frame two selection button 116 is not activated the controller circuit 502 determines whether the frame three selection button is activated (block 612). If the frame three selection button 118 is activated the controller circuit 502 plays the audio segment associated with image three on frame three (block 614). If the frame three selection button 118 is not activated the controller circuit 502 determines whether the frame four selection button 120 is activated (block 616). If the frame four selection button 120 is activated the controller circuit 502 plays the audio segment associated with image four on frame four (block 618). If the frame four selection button 120 is not activated the controller circuit 502 plays the audio segment associated with the front display image (block 620). Therefore, as demonstrated, front play button algorithm 600 allows the user to play an audio segment associated with an image without too much of effort by the user. It will be apparent to an individual skilled in the art that separate play buttons for each image may be provided on the image display device 100 allowing the user to select an audio segment for play by selecting the specific play button without the use of the above method associated with FIG. 6.

FIG. 7 is a flowchart illustrating a method of recording an audio segment based on an image that is displayed in accordance. Referring to FIG. 7, the controller circuit 502 selects the correct storage location in memory 504 to record an audio segment based on the record button algorithm 700. The algorithm allows the controller circuit 502 to determine which image the user is currently viewing and records an audio segment corresponding to that image when the user presses the record button 128. Once the user presses the record button 128 (block 702), the controller circuit 502 determines if the record lock 132 is activated (block 704). If the record lock 132 is activated the controller circuit 502 does not record the audio segment (block 706). If the record lock 132 is not activated the controller circuit 502 activates the record LED (block 708). The controller circuit 502 next determines if the frame one selection button 114 is activated (block 710). If the frame one selection button 114 is activated the controller circuit 502 records the audio segment to a location in memory 504 associated with image one on frame one (block 712). If the frame one selection button 114 is not activated the controller circuit 502 determines whether the frame two selection button 116 is activated (block 714). If the frame two selection button 116 is activated the controller circuit 502 records the audio segment to a location in memory 504 associated with image two on frame two (block 716). If the frame two selection button 116 is not activated the controller circuit 502 determines whether the frame three selection button 118 is activated (block 718). If the frame three selection button 118 is activated the controller circuit 502 records the audio segment to a location in memory 504 associated with image three on frame three (block 720). If the frame three selection button 118 is not activated the controller circuit 502 determines whether the frame four selection button 120 is activated (block 722). If the frame four selection button 120 is activated the controller circuit 502 records the audio segment to a location in memory 504 associated with image four on frame four (block 724). If the frame four selection button 120 is not activated the controller circuit 502 records the audio segment to a location in memory 504 associated with the front display image 726. It should be noted that the audio segment is received via the microphone 508 or any device capable of receiving an audio input, or store an audio segment such as, but not limited to, a floppy disc or compact disc read only memory (CD-ROM). The record button algorithm 700 allows the user to record an audio segment to a location in memory 504 associated with an image, without too much effort by the user.

FIG. 8 is a schematic diagram providing a top perspective view of an image display with audio device. Referring to FIG. 8, a top perspective view of an image display with audio device is shown, in accordance with the second exemplary embodiment of the invention. The image display device 800 has a front display 802, a back display 803, and four frames 804, 806, 808, 810 stored within the image display device 800. The image in the front display 802 is inserted within the front cover 812 and provides for a permanent display of the image. The image in the back display 803 is inserted within the back cover and also provides for permanent display of the image. The four frames 804, 806, 808, 810 allow a user to temporarily secure the frames 804, 806, 808, 810 within the image display device 800 and temporarily display the image by selecting the frame. Each frame 804, 806, 808, 810 displays two images, one image on the front surface of the frame and one image on the back surface of the frame. As an example, frame one 804 displays image one on the front surface 112 while image eight is displayed on the back surface. Frame two 806 displays image two on the front surface while image seven is displayed on the back surface. Frame three 808 displays image three on the front surface 112 while image six is displayed on the back surface. Frame four 810 displays image four on the front surface 112 while image five is displayed on the back surface.

Similar to the first embodiment, the image display device 800 of the second exemplary embodiment also includes components for playing and recording audio segments. The front display 802, back display 803, and each of the eight images on the four frames 804, 806, 808, and 810 can have an audio segment associated with them. The user plays the audio segment by pressing one of the frame selection buttons 814, 816, 818, 820 and pressing either the front play button 822 or the back play button 823. The audio segment is then broadcast over the speaker 824 located on the front side of the image display device 800. The method and components used to play audio segments are discussed in more detail in the specification sections associated with FIGS. 5 and 9.

Similar to the first embodiment, the image display device 800 also has a microphone 826 and record button 828 to allow the user to record an audio segment. Each of the eight images on the four frames 804, 806, 808, 810, back display 803 and front display 802 can have an audio segment associated with the image. To record an audio segment, the user selects the image to record the respective audio segment, switches the image record selector 829 based on the intended image, presses the record button 828 and speaks into the microphone 826. A record LED 830 illuminates when recording, thereby signaling to the user that the audio segment is being recorded. At the completion of the audio segment the user releases the record button 828 and the audio segment is stored for later playback. To prevent accidentally recording over an audio segment the image display housing 800 also has a record lock 832. When the record lock 832 is activated the user is prevented from recording an audio segment. This allows a user that wishes to save a recording for long term or permanently to prevent the accidental recording over of a previously recorded audio segment. When the record lock 832 is deactivated the user can again record over previously recorded audio segments. The method and components used to record audio segments are discussed in more detail in the specification sections associated with FIGS. 5 and 10.

Referring to FIG. 9, the controller circuit 502 for the second embodiment selects the correct audio segment to play based on whether the front play button 822 or back play button 823 is selected. If the front play button 822 is selected the controller circuit 502 follows the same front play button 822 algorithm 600 as discussed for the first embodiment and shown in FIG. 6. If the back play button 823 is selected the controller circuit 502 follows the back play button algorithm 900 shown in FIG. 9. Both the front play button algorithm 600 and the back play button algorithm 900 allow the controller circuit 502 to determine which image the user is currently viewing and play the audio segment corresponding to that image with the user only pressing either the front play button 822 or back play button 823. Once the user presses the back play button 902, the controller circuit determines if the frame one selection button is activated 904. If the frame one selection button is activated the controller circuit plays the audio segment associated with image eight on frame one 906. If the frame one selection button is not activated the controller circuit determines whether the frame two selection button is activated 908. If the frame two selection button is activated the controller circuit plays the audio segment associated with image seven on frame two 910. If the frame two selection button is not activated the controller circuit determines whether the frame three selection button is activated 912. If the frame three selection button is activated the controller circuit plays the audio segment associated with image six on frame three 914. If the frame three selection button is not activated the controller circuit determines whether the frame four selection button is activated 916. If the frame four selection button is activated the controller circuit plays the audio segment associated with image five on frame four 918. If the frame four selection button is not activated the controller circuit plays the audio segment associated with the back display image 920. The back play button algorithm 900 and front play button algorithm 600 allow the user to play an audio segment associated with an image without too much effort by the user.

Referring to FIG. 10, the controller circuit 502 for the second embodiment selects the correct storage location in memory 504 to record an audio segment based on the record button algorithm 1000 for the second embodiment. The algorithm allows the controller circuit 502 to determine which image the user is currently viewing and records an audio segment corresponding to that image with the user only having to switch the image record selector 829 and press the record button 828. Once the user presses the record button 1002, the controller circuit determines if the record lock is activated 1004. If the record lock is activated the controller circuit does not record the audio segment 1006. If the record lock is not activated the controller circuit activates the record LED 1008. The controller circuit next determines if the image record selector is set to front or back 1009. If the image record selector is set to front the controller circuit follows the same algorithm starting at block 710 in FIG. 7 associated with the first embodiment 1011. If the image record selector is set to back the controller circuit next determines if the frame one selection button is activated 1010. If the frame one selection button is activated the controller circuit records the audio segment to a location in memory associated with image eight on frame one 1012. If the frame one selection button is not activated the controller circuit determines whether the frame two selection button is activated 1014. If the frame two selection button is activated the controller circuit records the audio segment to a location in memory associated with image seven on frame two 1016. If the frame two selection button is not activated the controller circuit determines whether the frame three selection button is activated 1018. If the frame three selection button is activated the controller circuit records the audio segment to a location in memory associated with image six on frame three 1020. If the frame three selection button is not activated the controller circuit determines whether the frame four selection button is activated 1022. If the frame four selection button is activated the controller circuit records the audio segment to a location in memory associated with image five on frame four 1024. If the frame four selection button is not activated the controller circuit records the audio segment to a location in memory associated with the back display image 1026. The record button algorithm for the second embodiment 1000 allows the user to record an audio segment to location in memory associated with an image without too much effort by the user. It will be apparent to an individual skilled in the art that the above method associated with FIG. 10 can also be used for selecting audio segments for play. The user may select the audio segment by using a selector similar to the record selector 829. Based on the position of the selector, the controller circuit 502 determines whether to play an audio segment associated with a front side image or to play an audio segment associated with a back side image.

It should be emphasized that the above-described embodiments of the present invention, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. An image display, comprising:
one or more exterior images displayed on an exterior surface of an image display housing;
one or more interior images stored within the image display housing and removably displayed on one or more interior frames;
an audio storage with one or more audio segments associated with exterior and interior images; and
an audio player wherein activation by a first play button broadcast one of the one or more audio segments.

2. The image display of claim 1, further comprising:
one or more frame selection buttons wherein activation of one of the one or more frame selection buttons displays one or more of the interior images by moving one of the one or more frames out of the image display housing.

3. The image display of claim 1, further comprising:
one or more frame selection buttons associated with the one or more interior frames; and
a control circuit wherein the control circuit selects one of the audio segments to broadcast based on activation of the first play button and activation of one or none of the one or more frame selection buttons.

4. The image display of claim 1, further comprising:
one or more frame selection buttons associated with the one or more interior frames;
an audio recorder wherein activation by a record button records one of the one or more audio segments to the audio storage; and
a control circuit wherein the control circuit identifies one of the one or more recorded audio segment with an associated image based on activation of the record button and activation of one or none of the one or more frame selection buttons.

5. The image display of claim 1, wherein one interior image is displayed on a front and another interior image is displayed on a back of each of the one or more interior frames.

6. The image display of claim 1, further comprising:
one or more frame selection buttons associated with the one or more interior frames; and
a control circuit wherein the control circuit selects one of the audio segments to broadcast based on activation of the first play button or a second play button and activation of one or none of the one or more frame selection buttons.

7. The image display of claim 6, wherein the first play button is associated with images on a front side of each of the one or more interior frames and the second play button is associated with images on a back side of each of the one or more interior frames.

8. The image display of claim 1, further comprising:
one or more frame selection buttons associated with the one or more interior frames;
an audio recorder wherein activation by a record button records one of the one or more audio segments to the audio storage; and
a control circuit wherein the control circuit identifies one of the one or more recorded audio segment with an associated image based on activation of the record button, an image record selector, and activation of one or none of the one or more frame selection buttons.

9. The image display of claim 8, wherein the image record selector differentiates between images on a front side of each of the one or more interior frames and images on a back side of each of the one or more interior frames.

10. A method for associating audio segments with images in an image display, comprising the steps of:
receiving a signal from a first play button; and
selecting and playing an audio segment associated with an image based on receiving a signal from one or none of one or more frame selection buttons associated with one of one or more frames of the image display and receiving the signal from the first play button.

11. The method of claim 10, further comprising the step of:
selecting and playing an audio segment associate an exterior image when none of the one or more frame selection button signals is received.

12. The method of claim 10, further comprising the step of:
selecting an audio segment associate an interior image for play when one of the one or more frame selection button signals is received.

13. The method of claim 10, further comprising the steps of:
receiving a signal from a second play button;
selecting and playing an audio segment associate with a back facing image when one or none of the one or more frame selection buttons is activated and the signal for the second play button is received; and
selecting and playing an audio segment associated with a front facing image when one or none of the one or more frame selection button is activated and the signal for the first play button is received.

14. An image display, comprising the steps of:
one or more exterior image display means on an exterior surface of an image display housing;
one or more interior image display means stored within the image display housing and removably displayed;
an audio storage means with one or more audio segments associated with each exterior image display means and interior image display means; and
an audio playing means wherein activation by a first play button broadcast one of the one or more audio segments.

15. The image display of claim 14, further comprising the step of:
one or more interior display means selection switches wherein activation of one of the one or more interior display means selection switches displays one or more of the interior display means by moving one of the one or more interior image display means out of the image display housing.

16. The image display of claim 14, further comprising the steps of:
one or more interior display means selection switches associated with the one or more interior image display means; and
a control means wherein the control means selects one of the audio segments to broadcast based on activation of the first play button and activation of one or none of the one or more interior display means selection switches.

17. The image display of claim 14, further comprising the steps of:
one or more interior means for display selection switches associated with the one or more interior display means;
means for audio recording wherein activation by a record button records one of the one or more audio segments to the audio storage means; and
means for control wherein the means for control identifies one of the one or more recorded audio segment with an associated image based on activation of the record button and activation of one or none of the one or more interior means for display selection switches.

18. The image display of claim 14, wherein one image is displayed on a front side and another image is displayed on a back side of each of the one or more interior means for display.

19. The image display of claim 14, further comprising the steps of:
one or more interior means for display selection switches associated with the one or more interior means for display; and
means for control wherein the means for control selects one of the audio segments to broadcast based on activation of a first play button or a second play button and activation of one or none of the one or more interior means for display selection switches.

20. The image display of claim 18, wherein the first play button is associated with images on a front side of each of the one or more interior means for display and a second play button is associated with images on a back side of each of the one or more interior means for display.

21. The image display of claim 14, further comprising the steps of:
one or more interior means for display selection switches associated with the one or more interior means for display;
means for audio recording wherein activation by a record button records the one or more audio segments to the audio storage means; and
means for control wherein the means for control identifies one of the one or more recorded audio segment with an associated image based on activation of the record button, an image record selector, and activation of one or none of the one or more interior means for display selection switches.

22. The image display of claim 21, wherein the image record selector differentiates between images on a front side of each of the one or more interior means for display and images on a back side of each of the one or more interior means for display.
